(19) United States
(12) Patent Application Publication
(10) Pub. No.: US 2025/0013478 A1
(43) Pub. Date: Jan. 9, 2025

(54) METHOD, APPARATUS, DEVICE, AND STORAGE MEDIUM FOR PROCESSING INFORMATION

(71) Applicant: Beijing Zitiao Network Technology Co., Ltd., Beijing (CN)

(72) Inventors: Yizhe Yang, Beijing (CN); Jiahe Ma, Beijing (CN); Chong Niu, Beijing (CN); Ang Zhang, Beijing (CN); Huiming Wang, Beijing (CN)

(21) Appl. No.: 18/888,078

(22) Filed: Sep. 17, 2024

(30) Foreign Application Priority Data
Sep. 18, 2023 (CN) 202311206410.7

(51) Int. Cl. G06F 9/451

(52) U.S. Cl. CPC G06F 9/453

(57) ABSTRACT

The embodiment of the disclosure provides a method, an apparatus, a device and a storage medium for processing information. The method includes: opening a session in response to a predetermined operation associated with an application; obtaining a target message input by a user in the session, wherein both the user and a digital assistant are members of the session, and the target message is sent for the digital assistant by the user; obtaining operation information of the user in the application; and sending the target message and the operation information to a server. Therefore, relevant operation information of the user in the application may be provided, and the semantics of the user may be better understood when the user is replied. This may facilitate improving the accuracy of the digital assistant reply.

### CROSS-REFERENCE

The present application claims priority to Chinese Patent Application No. 202311206410.7, filed on Sep. 18, 2023, and entitled “METHOD, APPARATUS, DEVICE, AND STORAGE MEDIUM FOR PROCESSING INFORMATION”, the entirety of which is incorporated herein by reference.

### FIELD

Example embodiments of the present disclosure generally relate to the field of computers, and in particular, to a method, an apparatus, a device, and computer-readable storage medium for processing information.

### BACKGROUND

With the development of information technologies, various terminal devices may provide various services to people in work and life. For example, an application providing a service may be deployed in the terminal device. A terminal device or an application thereof may provide a function such as an assistant to a user, to assist the user in completing a task by using a terminal device or an application. How to make such assistant functions more efficient and accurate in serving users is currently a technical issue being explored.

### SUMMARY

In a first aspect of the present disclosure, a method for processing information is provided. The method comprises: opening a session in response to a predetermined operation associated with an application; obtaining a target message input by a user in the session; wherein both the user and a digital assistant are members of the session, and the target message is sent for the digital assistant by the user; obtaining operation information of the user in the application; and sending the target message and the operation information to a server.

In a second aspect of the present disclosure, an apparatus for processing information is provided. The apparatus comprises: a session opening module, configured to open a session in response to a predetermined operation associated with an application; a target message obtaining module, configured to obtain a target message input by a user in the session; wherein both the user and a digital assistant are members of the session, and the target message is sent for the digital assistant by the user; an operation information obtaining module, configured to obtain operation information of the user in the application; and a sending module, configured to send the target message and the operation information to a server.

In a third aspect of the present disclosure, an electronic device is provided. The electronic device comprises: at least one processing unit; and at least one memory coupled to the at least one processing unit and storing instructions for execution by the at least one processing unit. The instructions, when executed by the at least one processing unit, causes the electronic device to perform the method of the first aspect.

In a fourth aspect of the present disclosure, a computer-readable storage medium is provided. The computer-readable storage medium has a computer program stored thereon, wherein the computer program may be executed by a processor to implement the method of the first aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRA WINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

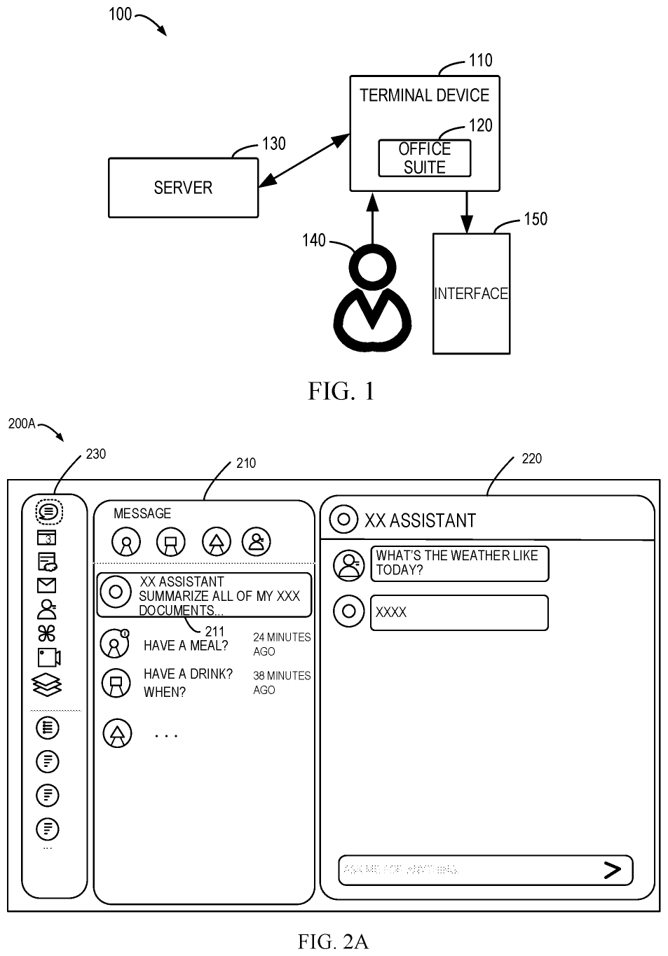

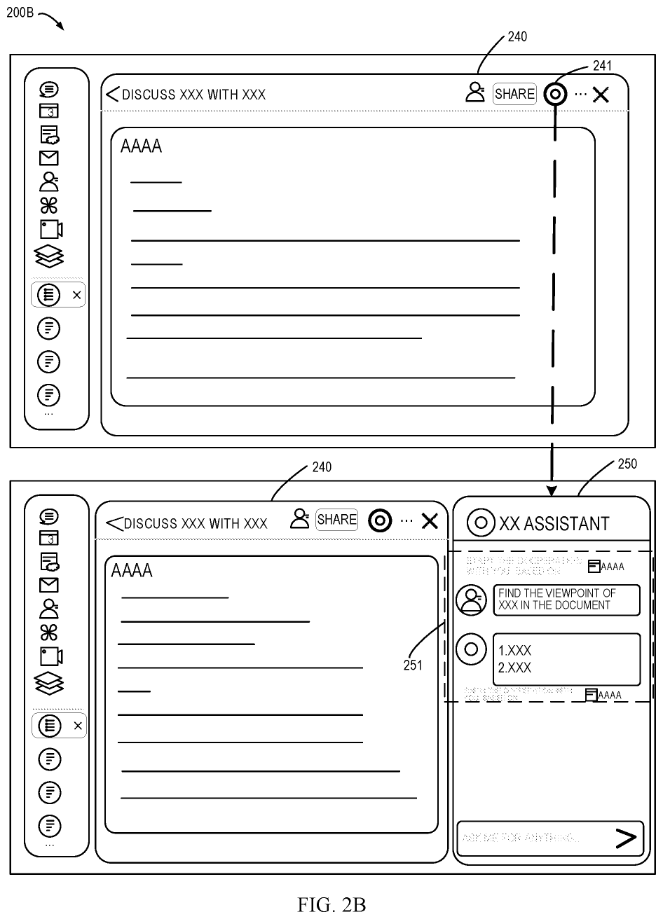

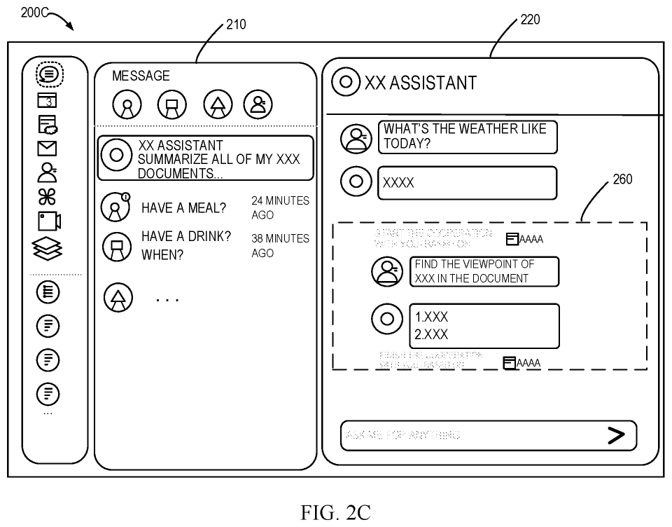

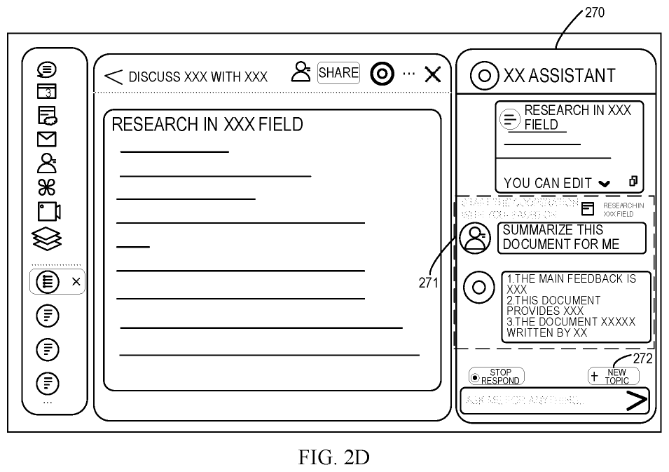

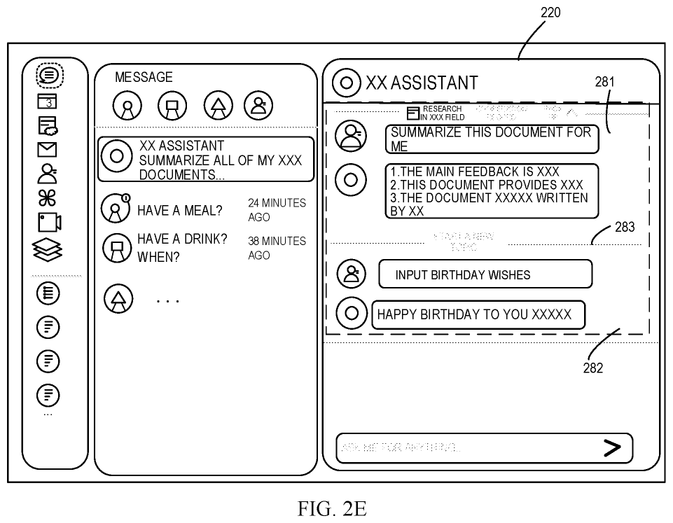

FIGS. 2A-2E illustrate schematic diagrams of example interfaces of a main session window and sub-session windows according to some embodiments;

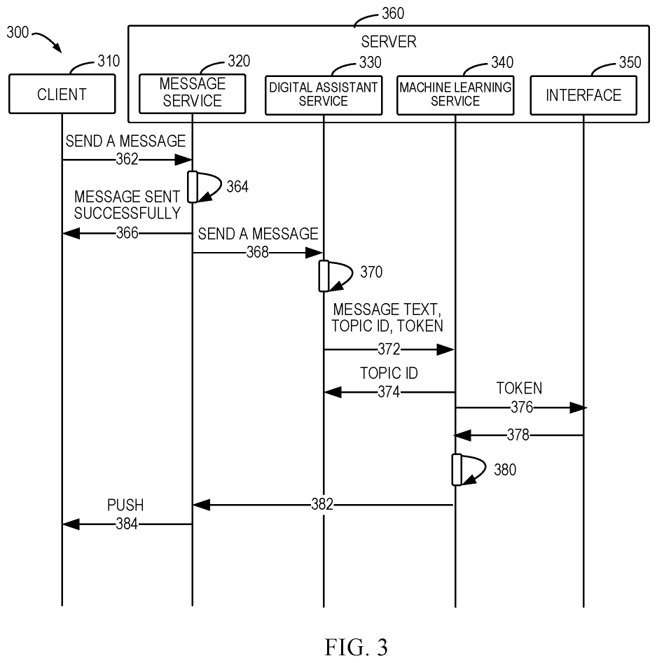

FIG. 3 illustrates an example process of communicating interaction message between a user and a digital assistant according to some embodiments;

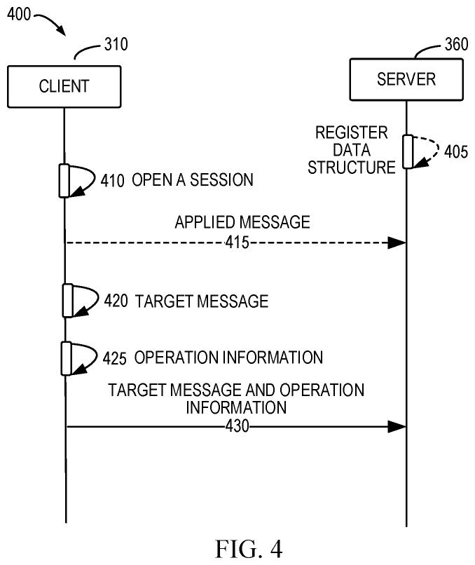

FIG. 4 illustrates an example process of communicating operation information of user in an application according to some embodiments;

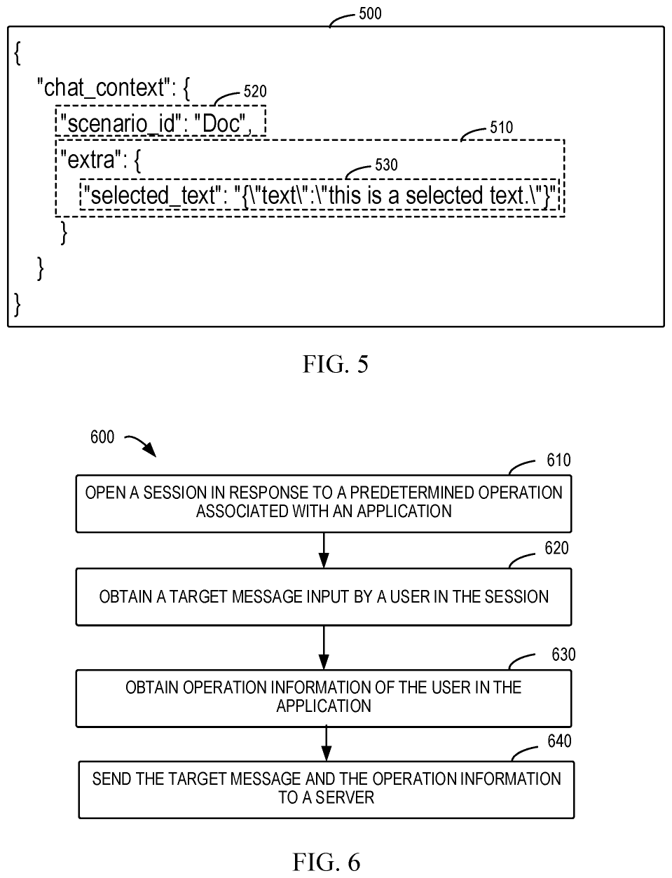

FIG. 5 illustrates one example of a data structure for operation information according to some embodiments;

FIG. 6 is a schematic flowchart of a method for processing information according to some embodiments;

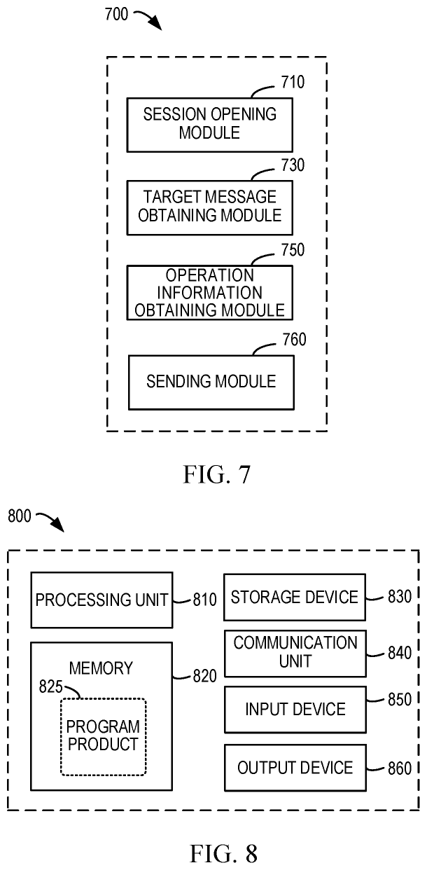

FIG. 7 illustrates a block diagram of an apparatus for processing information according to some embodiments; and

FIG. 8 illustrates a block diagram of a device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein. Rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “comprise” and its variants are to be read as open terms that mean “include, but is not limited to”. The term “based on” is to be read as “based at least in part on”. The term “one embodiment” or “this embodiment” is to be read as “at least one embodiment”. The term “some embodiments” is to be read as “at least some embodiments”. Other definitions, explicit and implicit, might be included below.

Herein, unless explicitly stated, “in response to A” performing one step does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It can be understood that before using the technical solutions disclosed in the embodiments of the present disclosure, relevant user should be informed of the types, use ranges, usage scenarios, and the like of the information related to the present disclosure in an appropriate manner according to relevant laws and regulations, and the authorization of the related user may be obtained, wherein the relevant users may include any type of rights body, such as individuals, businesses, and groups.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operation of the technical solution of the present disclosure according to the prompt information, such as an electronic device, application program or storage medium.

As an optional but non-limiting implementation, in response to receiving the active request of the user, the manner of sending the prompt information to the user may be, for example, a pop-up window, and the prompt information may be presented in text in the pop-up window. In addition, the pop-up window may further carry a selection control for the user to select “agree” or “disagree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

FIG. 1 illustrates a schematic diagram of an example environment 100 in which embodiments of the present disclosure may be implemented. In this example environment 100, an office suite 120 is installed in the terminal device 110. The user 140 may interact with the office suite 120 via the terminal device 110 and/or an attachment device of the terminal device 110. The office suite 120 is able to provide integration of multiple applications or components to the user 140. These applications may serve as application modules in the office suite 120. The applications integrated in the office suite 120 are sometimes referred to as “office applications”, “office components”, “collaborative office platforms”, and the like. As an example, applications integrated in the office suite 120 may comprise, but are not limited to, one or more of: a chat application (also referred to as an instant messaging (IM) application), a document application, an audio and video conferencing application, a mail application, a calendar application, a schedule application, a task application, an objectives and key result (OKR) application.

In some embodiments, the office suite 120 may be downloaded as an application, installed on the terminal device 110. In some embodiments, the office suite 120 may also be accessed in other manners, such as via web page access.

In the environment 100 of FIG. 1, if the office suite 120 is enabled, the terminal device 110 may present an interface 150 of the office suite 120 to the user 140. Interface 150 is also sometimes referred to as a client interface. The interface 150 may include various interfaces that can be provided by the office suite 120, such as a session interface presenting chat content, a video conference interface, a file sharing interface, and the like.

In some embodiments, terminal device 110 communicates with server 130 to enable provision of services to office suite 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 may also support any type of interface for a user (such as a “wearable” circuit, and the like). The server 130 may be various types of computing systems/servers capable of providing computing power, including, but not limited to, mainframes, edge computing nodes, computing devices in a cloud environment, and the like.

It should be understood that the structures and functions of the various elements in the environment 100 are described for exemplary purposes only and do not imply any limitation to the scope of the present disclosure. For example, embodiments of the present disclosure may be applied to any suitable one or more applications, not limited to office suites.

As briefly mentioned above, a digital assistant may be provided to the user to assist the user in completing the target task using the terminal device or application. In an embodiment of the present disclosure, a digital assistant is configured for the user 140. The digital assistant may be implemented in any suitable form. In some embodiments, the digital assistant of user 140 may interact with a user 140 as his/her contact. Such a digital assistant may also uniquely correspond to user 140. In other words, the digital assistant of the user 140 may be specific or exclusive to the user 140. In some embodiments, if the user 140 is an individual or person, such a digital assistant may be considered as personal digital assistant. It may be understood that the digital assistant in the embodiments of the present disclosure is based on the authorization of the user 140 to access the data to be granted.

It should be understood that the “uniquely correspond to” or the like in this disclosure is not intended to limit that the digital assistant will be updated accordingly based on the interaction process between the user 140 and the digital assistant.

In the embodiment of the present disclosure, after waking up the digital assistant through the predetermined application, the user 140 interacts with the digital assistant through the main session. The interaction window corresponding to the main session may be referred to as a main session window. As an example, the predetermined application may be an IM application in an office suite. In other examples, the predetermined application may also be another application or component.

One example of a main session window in an office suite is described with reference to FIG. 2A. The terminal device presents an interface 200A of the office suite. The interface 200A comprises a navigation bar 230 in which entry controls for a plurality of applications and access entries for a plurality of pages are displayed. By selecting these entry controls and access entries, a corresponding application or page may be activated for browsing or operation. In this example, the chat application is activated. Correspondingly, the interface 200A presents a feed page 210 of the chat application, that is, a session entry list. The session entry item 211 between the user and the digital assistant (“XX assistant” in FIG. 2) is displayed in the feed page 210. The user may click the session entry item 211 of the “XX assistant” such that the main session window 220 is presented.

In an embodiment of the present disclosure, the session entry with the digital assistant may also be in the contact list. The user may open the main session window 220 with the digital assistant by triggering the session entry of the digital assistant in the contact list.

In the above examples and the examples below, the digital assistant is shown with the name of “XX assistant”, but it should be understood that this is merely exemplary and not intended to limit the scope of the present disclosure. In embodiments of the present disclosure, the digital assistant may have any suitable name, and the user 140 may customize the name of the digital assistant.

In some embodiments of the present disclosure, other applications than the predetermined application may be used to wake up and then interact with the digital assistant. After the digital assistant is woken up through these non-predetermined applications, the user and the digital assistant may interact with each other through a sub-session. An interaction window corresponding to the sub-session may be referred to as a sub-session window. For example, a user may wake up a digital assistant through a page in a document application, then interact with a digital assistant through a sub-session.

Certainly, in some embodiments, after the digital assistant is woken up through these non-predetermined applications, the user and the digital assistant may also interact with each other through the main session. In the following embodiments, a sub-session is taken as an example for description.

One example of a sub-session window in an office suite is described with reference to FIG. 2B. The terminal device presents an interface 200B of the office suite. In this example, the opened document page 240 is presented in the interface 200B. In this document page 240, an option or control 241 associated with the digital assistant is presented. The user may click on the control 241 to wake up the digital assistant, presenting the sub-session window 250. In this example, the sub-session window 250 is displayed with prompt information “start the cooperation with you-based on AAAA”. Further, the user may interact with the digital assistant through the sub-session window 250. An interaction message (as indicated by dashed box 251) may be presented in the sub-session window 250.

The sub-session between the user and the digital assistant is described above with the document application as an example. It should be understood, however, that user may wake up the digital assistant by any other suitable application.

In some embodiments, the interaction messages in the sub-session window may be displayed in aggregated form in the main session window. As an example, referring to FIGS. 2B and 2C, an interaction message (as indicated by dashed box 251) in the sub-session window 250 presented in the interface 200B is shown in the main session window 220 of the interface 200C in an aggregated form of message records (as indicated by dashed box 260). The aggregated form here may refer to that the message records in the sub-session window 250 are presented in a centralized manner, for example, centrally presented in the position indicated in the dotted box 260, with no other messages inserted therein. Therefore, the interaction message between the user and the digital assistant may be recorded in a unified manner, so that the interaction message may be traced back. It is advantageous to provide a user with an efficient assistance experience.

In an embodiment of the present disclosure, the user and the digital assistant may interact with different topics through the main session and the sub-session. For example, referring to FIG. 2D, a control 272 for opening a new topic is displayed in the sub-session window 270. If the user 140 clicks on the control 272, the topic involved in the interaction in the dotted box 271 may be ended and a new topic started. Accordingly, the message records of the sub-session window 270 presented in the main session window may comprise interaction messages of different topics, and messages under different topics may be distinguished. As an example, referring to FIG. 2E, message records for one topic in the sub-session window 270 are presented in the region 281 of the main session window 220, and message records for another topic are presented in the region 282. The new topic is isolated from the previous topic by an identification 283 that “opens a new topic”.

For the same topic, a multi-round session may need to be performed between the user and the digital assistant. In some scenarios, more natural communication and dialogue may be performed between the user and the digital assistant by using deep learning and natural language processing technologies and the like. In this case, the progress of the topic requires perceiving the context information of multiple rounds of conversations between the user and the digital assistant. In general, office suites may provide a variety of applications, such as chat applications (also known as messaging applications), document applications, table applications, mailbox applications, and the like. The digital assistant may also be invoked to talk to the user during the course in which the service corresponding to each application is provided.

That is, the user and the digital assistant may interact in different applications, while in each application the user may perform a variety of operations. In this case, the user's assistance request for the digital assistant is closely related to the user's operation in the application. For example, after the user opens a document A, a session window (a main session window or a sub-session window) with the digital assistant is woken up. The user selects a text paragraph in the document A, and sends a message request for “please translate this text paragraph into English” into the session window with the digital assistant. At this time, the digital assistant needs to know the content of the document paragraph selected by the user to correctly respond to the user's request. In view of this, embodiments of the present disclosure provide a solution for processing information. According to various embodiments of the present disclosure, a session is opened in response to a predetermined operation associated with an application, wherein both the user and a digital assistant are members of the session. A target message input by a user in the session and the operation information of the user in the application are obtained. Then, the target message and operation information are sent to server. In this way, the context information of the user in the application may be transferred to the server for consideration when replying to the user. This helps the digital assistant better understand the semantics of the user, thereby improving the accuracy of answering in a specific application scenario. Thus, an efficient assistance experience may be advantageously provided to users in a multi-application scenario.

Example embodiments of the present disclosure are described in detail below with reference to the accompanying drawings. In order to more clearly understand the information processing solution of the present disclosure, an example process 300 for communicating interaction messages of a user and a digital assistant between a client and a server is described with reference to FIG. 3.

In the example of FIG. 3, client 310 may run at terminal device 110 for implementing office suite 120. The service end 360 may run at the server 130. Merely by way of example, the service end 360 may include, but is not limited to, a message service 320, a digital assistant service 330, a machine learning service 340, and an interface 350. The message service 320 may be used, for example, to provide services related to messaging applications in office suite 120. The digital assistant service 330 may be used, for example, to provide services related to digital assistants. The machine learning service 340 may utilize any suitable machine learning model to provide various suitable services in the office suite 120, for example, a machine learning model may be utilized when generating an answer to the user by the digital assistant. The interface 350 may be, for example, an open application program interface, and the application provides its own capabilities or resources to other applications for calling or obtaining through an interface.

In particular, FIG. 3 illustrates an example process 300 for a single round conversation between a user 140 and a digital assistant. The user 140 sends a message to the digital assistant through the client 310. As shown in FIG. 3, the client 310 sends (362) a message from the user 140 to the message service 320. The message service 320 determines (364) whether the message was successfully received. If successful, the message service 320 sends (366) a notification to the client 310 that the message was successfully sent. The message service 320 then sends (368) a message received from client 310 to digital assistant service 330 and instructs digital assistant service 330 that user 140 sends a message to the digital assistant.

The digital assistant service 330 may determine (370) a topic identification of a topic to which the message belongs, and obtain context information of the topic to which the message belongs based on the topic identification. The digital assistant service 330 may then send (372) information related to the context information to the machine learning service 340, such as, but not limited to, message text, topic identification, token, and the like.

The machine learning service 340 may extract the topic ID from the received information and return (374) to the digital assistant service 430, thereby indicating that information about the topic ID has been successfully received. Additionally, in some embodiments, the machine learning service 340 may send (376) a token extracted from the received information to interface 350 for the application to authenticate whether the message is a legitimate message or whether is authorized to process the message, or the like. Accordingly, the interface 350 may conduct corresponding authentication and send (378) the authentication results to the machine learning service 340.

The machine learning service 340 may obtain (380) a message to be returned to the user 140 by performing some processing on the context information, for example, using a machine learning model or the like. In some embodiments, in the reply process, the message to reply may, for example, be returned (382) to the message service 320 in a streaming form and then pushed (384) by the message service 320 to the client 310.

In the case of a multi-turn conversation, a process similar to process 300 may be performed for each round of conversation.

The above describes an example process of communicating an interaction message between a client and a server. An example process 400 for communicating interaction information between a server and a client is described below with reference to FIG. 4.

As shown in FIG. 4, in response to a predetermined operation associated with the application, the client 310 may open (410) the session. Both the user 140 and the digital assistant are members of the session. For example, the user 140 may open the session by triggering a predetermined control in the application, such as the control 241 shown in FIG. 2B.

In some embodiments, the session may be a group chat session, and the user 140 and the digital assistant are members of the group chat session. In some embodiments, the session may be a single session between the user 140 and the digital assistant. For example, the session may be a sub-session between the user 140 and the digital assistant, such as described above with reference to FIG. 2B.

The client 310 may obtain (420) a target message input by the user 140 in the session. The target message is sent by the user 140 to the digital assistant. For example, in the case of a single chat session, the user 140 may input the target message in a session window. For another example, in the case of a group chat session, the target message may be a message input by the user 140 referring to the digital assistant, or a message that references a previous reply of the digital assistant. The target message may be in natural language form.

In some embodiments, the client 310 may send (415) information of the application to the service end 360. For example, during the session initialization process, the client 310 may send the information about the application to the service end 360. The information about the application may be considered as a fixed parameter of the session.

The information of the application may comprise any suitable information capable of assisting the digital assistant in understanding the task requested by the user. For example, the information of the application may comprise a type of the application, for example, a document application, a mail application, a calendar application, and the like. Alternatively or additionally, the information of the application may comprise a link in the application that is associated with the session. For example, if the session is triggered by a certain document in a document application (such as user 140 clicking on control 241 in the document page), the information of the application may comprise a link to the document.

The client 310 may obtain (425) operation information of the user 140 in the application. In addition to inputting the target message in the session window, the user 140 may make one or more operations related to the target message in the application. For example, in the case of a document application, the user 140 may input a target message “help me to modify the content of this part”, and may select a portion of content in the document accordingly. As another example, in the case of a calendar application, the user 140 may input a target message “please help me schedule a meeting that starts at 2 p.m. this afternoon” and specify a date in the calendar accordingly.

The operational information may comprise any suitable information capable of identifying the operation of the user. For example, the operation information may comprise a type of operation of the user 140 in the application. Alternatively or additionally, the operation information may comprise content targeted by the operation of the user in the application. Continuing the above example with respect to the document application, the type of operation of “selecting a part of content in the document” may be a text selection, and the content targeted by the operation may be content selected by the user 140. For an example of a calendar application, the type of operation of “specifying a date in the calendar” may be a date designation, the content targeted for the operation may be the date specified by the user 140.

In some embodiments, in order to facilitate obtaining the operation information, an interface may be provided to the application, and the operation information sent by the application may be obtained through the interface. For example, when user 140 performs a related operation at the client 310, the application side may dynamically perceive context information of the operation. When the user 140 sends a message, the session component (e.g., the session is a sub-session component) may provide a callback interface to the application side. Accordingly, the application side may populate the operational information through the structure.

In some embodiments, in order to enhance uniformity among different applications, a data structure, also referred to as a first data structure, may be predefined for the operation information. The data structure may include one or more parameters for describing the operation of the user in the application. For example, the application side may fill the one or more parameters through a callback interface according to an operation of the user in the application.

One example of a data structure is described with reference to FIG. 5, which shows a data structure 500 named “chat_context”. The data structure 500 comprises a structure 510 named “extra” for operation information. In this example, the parameters and parameter values defined in structure 510 are represented in string format. As can be seen from the substructure 530 in the structure 510, the type of operation is a text selection, such as indicated by the field “selected_text”; and the substructure 530 includes the specific text selected. The data structure in this example has good expansibility, which can adapt to different applications and different operations in the application.

In the example of FIG. 5, data structure 500 also includes structure 520 for information of the application. As an example, the “scenario_id” field indicates the type of application, and the value “Doc” of the field indicates that the application is a document application. It should be understood that in some embodiments, the information of the application in the data structure 500 is not necessary. For example, if the information of the application is sent to the service end 360 during the session initialization process, the structure 520 may not be included.

It should be understood, however, that the data structure shown in FIG. 5 and the contents filled therein are exemplary and are not intended to limit the embodiments of the present disclosure. Any suitable data structure may be employed in embodiments of the present disclosure.

Reference is continued to FIG. 4. In some embodiments, the service end 360 may pre-register (405) the data structure described above. Specifically, the service end 360 (for example, the digital assistant service 330) may receive registration information of the application, and the registration information may include definition information of the data structure. For example, the registration information may define various parameter names, parameter values, and meanings in the data structure. For example, when the application side accesses a sub-session of the digital assistant service 330, related registration declarations may be performed, to list various types of information to be used subsequently and define data structures, and so on.

Process 400 continues to be described. After obtaining (420) the target message and obtaining (425) the operation information, the client 310 may send the target message and the operation information to the service end 360. For example, the target message and the operation information may be sent in association or together to the service end 360.

The target message and the operational information may be sent to the service end 360 in any suitable manner by any suitable link. In some embodiments, the target message and the operation information may be sent to the service end 360 through a message link. The message link is, for example, described above with reference to FIG. 3. For example, the client 310 may send the target message and the operation information to the message service 320 in the service end 360. The message service 320 may further send the received target message and the operation information to the digital assistant service 330. To provide a reply to the target message, the digital assistant service 330 may process the target message and the operational information. By way of example but not limitation, the processes described herein may include converting target messages and operation information into a form readable by a machine learning model. In addition, the processing may further include adding some additional information on the basis of the target message and the operation information, for example, information of an application obtained during the session initialization process. It can be understood that, for the same session, the information of the application is a fixed parameter, and the operation information is a dynamic parameter. By combining the fixed parameters with the dynamic parameters, complete context information may be represented. The processed target message and the operation information may then be sent to the machine learning service 340 to generate a task requested by the user. For example, the machine learning service 340 may assist a user in summarizing documents, scheduling meetings, and the like.

In this way, the machine learning service 340 may perceive the context associated with the application while processing the user's message. In this way, the semantics of the user can be better understood when the message of the user is processed, thereby making a more accurate answer. In addition, this advantageously supports user interaction with the digital assistant in a multi-application scenario.

The above describes a delivery mechanism of context information related to an application. To more clearly understand this delivery mechanism, one example scenario is described below. For example, the user 140 wakes up the digital assistant through the document application, for example, the user 140 clicks a control waking up the digital assistant from the page of the document A. Accordingly, a window of the sub-session may be presented at the client. The user selects a text paragraph in document A and enters the message “please help me continue writing this paragraph” through the sub-session window. The text selected by the user in the document A may be filled into a predefined data structure as part of the operation information. Then, the selected text is sent to the digital assistant service through the message link along with the message “please help me continue writing this paragraph”, and is further passed to the machine learning service to assist the user in completing the renewal of the selected text.

In this example, the text selected by the user in the document is the information belonging to the application side, and the text sent by the user belongs to the message of the instant messaging application. In the case of a sub-session, only the message sent by the user and the message returned by the digital assistant are presented in the interface of the client, and the relevant information of the application side is implicitly transferred to the server.

FIG. 6 shows a flowchart of a method 600 for processing information according to some embodiments. The method 600 may be implemented at the terminal device 110 and/or the server 130. The method 600 is described below with reference to FIG. 1.

At block 610, the terminal device 110 opens the session in response to a predetermined operation associated with the application.

At block 620, the terminal device 110 obtains a target message input by a user in the session. Both the user and a digital assistant are members of the session, and the target message is sent for the digital assistant by the user.

At block 630, the terminal device 110 obtains operation information of the user in the application.

In some embodiments, obtaining the operation information of the user in the application comprises: providing an interface to the application; obtaining the operation information of the user in the application sent by the application through the interface.

In some embodiments, a first data structure is predefined, the first data structure comprises one or more parameters, and the operation information has the first data structure.

In some embodiments, the one or more parameters and corresponding parameter values are represented in a string format.

In some embodiments, the method 600 further comprises: receiving, by the server, registration information of the application, wherein the registration information comprises definition information of the first data structure.

In some embodiments, the operation information comprises at least one of: a type of operation of the user in the application; a content targeted by the operation in the application.

At block 640, the terminal device 110 sends the target message and the operation information to a server.

In some embodiments, the method further comprises: sending information of the application to the server.

In some embodiments, the information of the application comprises at least one of: a type of the application; a link to a page associated with the session in the application.

In some embodiments, sending the target message and the operation information to the server comprises: sending the target message and the operation information to the service end a session message link.

In some embodiments, the session is a single chat session between the user and the digital assistant.

It should be understood that one or more of the steps, features, characteristics, or combinations thereof described with reference to the above example information processing methods may also be suitably incorporated into the method without departing from the subject matter of the method 600. This is not repeated herein.

FIG. 7 is a schematic structural block diagram of an apparatus 700 for processing information according to some embodiments of the present disclosure. The apparatus 700 may be implemented or included in the terminal device 110 and/or the server 130. The various modules/components in the apparatus 700 may be implemented by hardware, software, firmware, or any combination thereof.

As shown in FIG. 7, the apparatus 700 comprises a session opening module 710, configured to open a session in response to a predetermined operation associated with an application. The apparatus 700 comprises a target message obtaining module 720, configured to obtain a target message input by a user in the session; wherein both the user and a digital assistant are members of the session, and the target message is sent for the digital assistant by the user. The apparatus 700 comprises an operation information obtaining module 730, configured to obtain operation information of the user in the application. The apparatus 700 comprises a sending module 740, configured to send the target message and the operation information to a server.

In some embodiments, the operation information obtaining module 730 is further configured for: providing an interface to the application; obtaining the operation information of the user in the application sent by the application through the interface.

In some embodiments, a first data structure is predefined, the first data structure comprises one or more parameters, and the operation information has the first data structure.

In some embodiments, the one or more parameters and corresponding parameter values are represented in a string format.

In some embodiments, the apparatus 700 further comprises a registration module configured for: receiving, by the server, registration information of the application, wherein the registration information comprises definition information of the first data structure.

In some embodiments, the operation information comprises at least one of: a type of operation of the user in the application; a content targeted by the operation in the application.

In some embodiments, the sending module 740 is further configured for: sending information of the application to the server.

In some embodiments, the information of the application comprises at least one of: a type of the application; a link to a page associated with the session in the application.

In some embodiments, the sending module 740 is further configured for: sending the target message and the operation information to the service end through a session message link.

In some embodiments, the session is a single chat session between the user and the digital assistant.

FIG. 8 shows a block diagram of an electronic device 800 in which one or more embodiments of the present disclosure may be implemented. It should be understood that the electronic device 800 illustrated in FIG. 8 is merely exemplary and should not constitute any limitation on the functionality and scope of the embodiments described herein. The electronic device 800 shown in FIG. 8 may be configured to implement the terminal device 110 or the server 130 in FIG. 1.

As shown in FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and capable of performing various processes according to programs stored in the memory 820. In multiprocessor system, multiple processing units execute computer-executable instructions in parallel to improve parallel processing capabilities of electronic device 800.

Electronic device 800 typically includes a plurality of computer storage media. Such media may be any available media accessible to the electronic device 800, including, but not limited to, volatile and non-volatile media, removable and non-removable media. The memory 820 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 830 may be a removable or non-removable medium and may include a machine-readable medium, such as a flash drive, magnetic disk, or any other medium, which may be capable of storing information and/or data and may be accessed within electronic device 800.

The electronic device 800 may further include additional removable/non-removable, volatile/non-volatile storage media. Although not shown in FIG. 8, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 820 may include a computer program product 825 having one or more program modules configured to perform various methods or actions of various embodiments of the present disclosure.

The communication unit 840 is configured to communicate with another electronic device through a communication medium. Additionally, the functionality of components of the electronic device 800 may be implemented in a single computing cluster or multiple computing machines capable of communicating over a communication connection. Thus, the electronic device 800 may operate in a networked environment using logical connections with one or more other servers, network personal computers (PCs), or another network node.

The input device 850 may be one or more input devices, such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed, external devices such as storage devices, display devices, etc., communicate with one or more devices that enable a user to interact with the electronic device 800, or communicate with any device (e.g., a network card, a modem, etc.) that enables the electronic device 800 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram.

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for processing information, comprising:
opening a session in response to a predetermined operation associated with an application;
obtaining a target message input by a user in the session; wherein both the user and a digital assistant are members of the session, and the target message is sent for the digital assistant by the user;
obtaining operation information of the user in the application; and
sending the target message and the operation information to a server.

2. The method of claim 1, wherein obtaining the operation information of the user in the application comprises:
providing an interface to the application;
obtaining the operation information of the user in the application sent by the application through the interface.

3. The method of claim 1, wherein a first data structure is predefined, the first data structure comprises one or more parameters, and
the operation information has the first data structure.

4. The method of claim 3, wherein the one or more parameters and corresponding parameter values are represented in a string format.

5. The method of claim 3, further comprising:
receiving, by the server, registration information of the application, the registration information comprising definition information of the first data structure.

6. The method of claim 1, wherein the operation information comprises at least one of:
a type of operation of the user in the application;
a content targeted by the operation in the application.

7. The method of claim 1, further comprising:
sending information of the application to the server.

8. The method of claim 7, wherein the information of the application comprises at least one of:
a type of the application;
a link to a page associated with the session in the application.

9. The method of claim 1, wherein sending the target message and the operation information to the server comprises:
sending the target message and the operation information to the service end a session message link.

10. The method of claim 1, wherein the session is a single chat session between the user and the digital assistant.

11. An electronic device, comprising:
at least one processing unit; and
at least one memory coupled to the at least one processing unit and storing instructions for execution by the at least one processing unit, the instructions, when executed by the at least one processing unit, causing the electronic device to perform the operations comprising:
opening a session in response to a predetermined operation associated with an application;
obtaining a target message input by a user in the session; wherein both the user and a digital assistant are members of the session, and the target message is sent for the digital assistant by the user;
obtaining operation information of the user in the application; and
sending the target message and the operation information to a server.

12. The electronic device of claim 11, wherein obtaining the operation information of the user in the application comprises:
providing an interface to the application;
obtaining the operation information of the user in the application sent by the application through the interface.

13. The electronic device of claim 11, wherein a first data structure is predefined, the first data structure comprises one or more parameters, and
the operation information has the first data structure.

14. The electronic device of claim 13, wherein the one or more parameters and corresponding parameter values are represented in a string format.

15. The electronic device of claim 13, wherein the operations further comprise:
receiving, by the server, registration information of the application, the registration information comprising definition information of the first data structure.

16. The electronic device of claim 11, wherein the operation information comprises at least one of:
a type of operation of the user in the application;
a content targeted by the operation in the application.

17. The electronic device of claim 11, wherein the operations further comprise:
sending information of the application to the server.

18. The electronic device of claim 17, wherein the information of the application comprises at least one of:
a type of the application;
a link to a page associated with the session in the application.

19. The electronic device of claim 11, wherein sending the target message and the operation information to the server comprises:
sending the target message and the operation information to the service end a session message link.

20. A non-transitory computer-readable storage medium having a computer program stored thereon, the computer program being executable by a processor to implement operations comprising:
opening a session in response to a predetermined operation associated with an application;
obtaining a target message input by a user in the session; wherein both the user and a digital assistant are members of the session, and the target message is sent for the digital assistant by the user;
obtaining operation information of the user in the application; and
sending the target message and the operation information to a server.
